(19) United States
(12) Patent Application Publication
(10) Pub. No.: US 2018/0045532 A1
(43) Pub. Date: Feb. 15, 2018

(54) TRACING VEHICLE PATHS

(71) Applicant: International Business Machines Corporation, Armonk, NY (US)

(72) Inventors: Bryan P. Davidson, Seattle, WA (US); Michael E. Gildein, II, Wappingers Falls, NY (US); Angelo M. Quadara, New York, NY (US)

(21) Appl. No.: 15/791,461

(22) Filed: Oct. 24, 2017

Related U.S. Application Data
(63) Continuation of application No. 15/235,167, filed on Aug. 12, 2016.

(51) Int. Cl. G01C 21/36; G01S 5/02; G01C 21/34; G01S 19/42

(52) U.S. Cl. CPC G01C 21/3667; G01S 19/42; G01S 5/0294; G01C 21/3407; G01S 2205/002; G01S 2205/008

(57) ABSTRACT

A computer-implemented method includes responding to receiving a vehicle startup notification, by recording start location coordinates corresponding to that location where a vehicle is started. The method includes collecting onboard sensor data for the vehicle. The method includes tracking the vehicle's movement, based at least on the onboard sensor data to yield tracking data. The method includes storing the tracking data locally on the vehicle. The method includes responding to receiving a vehicle shutdown notification, by recording end location coordinates corresponding to that location where the vehicle is shut down. The method includes sending, via an external communication system, the start location coordinates, the tracking data, and the end location coordinates to an external system.

### BACKGROUND

The present invention relates generally to the field of vehicle routing and more particularly to tracing vehicle paths.

External systems may be capable of tracing the route a vehicle has taken from point A to point B. However, accomplishing this typically requires near constant communication between the vehicle and the external system. This near constant communication requires a strong and consistent connection, and promotes heavy network traffic between the external system and the vehicle. The global positioning system (“GPS”), or more generally, satellite navigation, is one such external system that may enable route tracing by an onboard or remote system. However, for the global positioning system to do so requires the near constant monitoring of GPS signals by a device on board the vehicle, necessitating certain power requirements.

### SUMMARY

A computer-implemented method includes responding to receiving a vehicle startup notification by recording start location coordinates corresponding to that location where a vehicle is started. The method includes collecting onboard sensor data for the vehicle. The method includes tracking the vehicle's movement, based at least on the onboard sensor data to yield tracking data. The method includes storing the tracking data locally on the vehicle. The method includes responding to receiving a vehicle shutdown notification by recording end location coordinates corresponding to that location where the vehicle is shut down. The method includes sending, via an external communication system, the start location coordinates, the tracking data, and the end location coordinates to an external system. A corresponding computer program product and computer system are disclosed.

In another aspect, a computer-implemented method includes receiving start location coordinates for a vehicle. The method includes receiving onboard tracking data for the vehicle. The method includes receiving end location coordinates for the vehicle. The method includes identifying a roadmap. The method includes tracing the onboard tracking data onto the roadmap from the start location coordinates to the end location coordinates to yield a vehicle path.

### BRIEF DESCRIPTION OF THE DRAWINGS

FIG. 1 is a block diagram of an operational environment suitable for operation of a vehicle tracking program, in accordance with at least one embodiment of the present invention.

FIG. 2 is a flowchart depicting operational steps for a vehicle tracking program, in accordance with at least one embodiment of the present invention.

FIG. 3 is a flowchart depicting operational steps for a vehicle tracking program sending tracking data to an external system, in accordance with at least one embodiment of the present invention.

FIG. 4 is a block diagram of components of an operational apparatus suitable for executing a vehicle tracking program, in accordance with at least one embodiment of the present invention.

### DETAILED DESCRIPTION

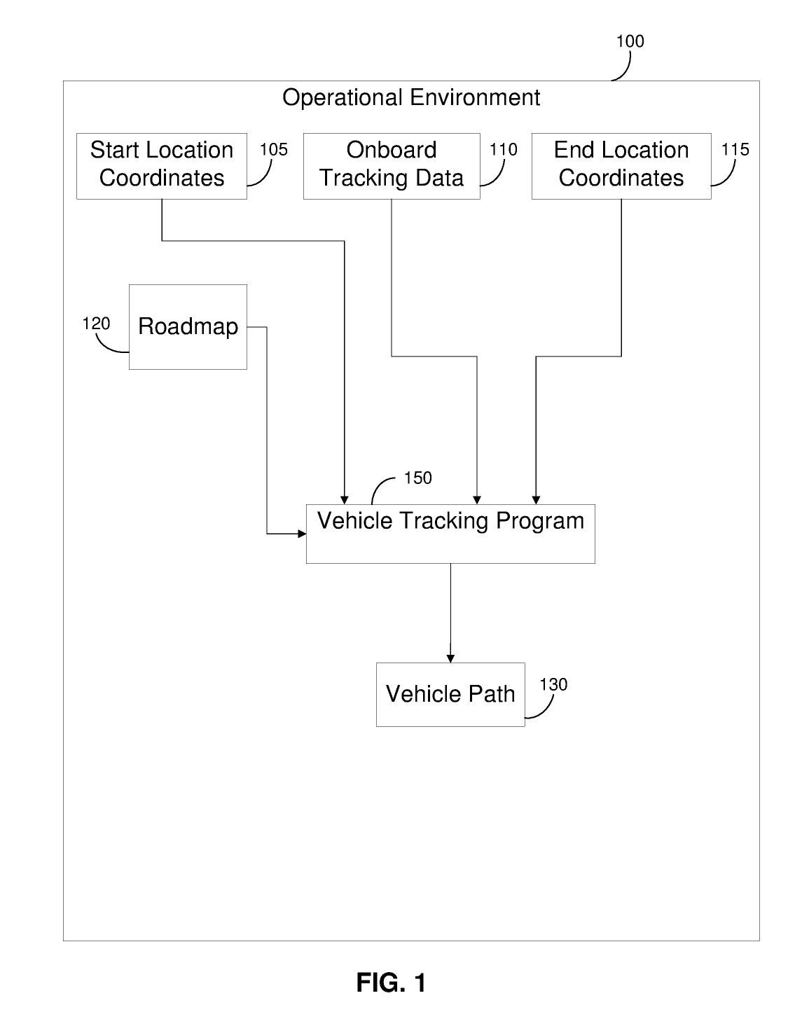

Referring now to the invention in more detail, FIG. 1 is a block diagram displaying an exemplary operational environment suitable for operation of at least one embodiment of the invention. An operational environment 100 includes start location coordinates 105, onboard tracking data 110, end location coordinates 115, a roadmap 120, a vehicle tracking program 150, and a vehicle path 130.

The vehicle tracking program 150 may receive the start location coordinates 105 as input. The vehicle tracking program 150 may receive the start location coordinates 105 from a vehicle responsive to a vehicle startup notification. A vehicle startup notification may be, for example, the vehicle ignition being started, the vehicle being put into drive, or the vehicle speedometer indicating that the vehicle is travelling. The start location coordinates 105 may be understood as Cartesian coordinates indicating the latitude, longitude, and/or elevation of the vehicle at the location where the vehicle is started.

The vehicle tracking program 150 may receive the end location coordinates 115 as input. The vehicle tracking program 150 may receive the end location coordinates 115 from a vehicle responsive to a vehicle shutdown notification. A vehicle shutdown notification may be, for example, the vehicle being shutdown, the vehicle ignition being turned off, or the vehicle speedometer indicating that the vehicle is no longer travelling. The end location coordinates 115 may be understood as Cartesian coordinates indicating the latitude, longitude, and/or elevation of the vehicle at the location where the vehicle is shut down.

According to various embodiments, the start location coordinates 105 and end location coordinates 115 may be either received, for example by momentary and/or single point reading of GPS signals or by reading from stored known coordinates, or inferred, for example by retrieving a stored previous end position, backtracking based on the sensor data from a known or inferred end position to infer a start location, or forward tracking based on the sensor data from a previously known or inferred end location. In particular, embodiments of the invention contemplate that both the start and end location may be inferred by forward tracking and/or backtracking from any previously known position, which could be long before the trip or intermediate to the trip.

The vehicle tracking program 150 may receive the onboard tracking data 110 as input. The onboard tracking data 110 may be onboard sensor data for the vehicle. Onboard vehicle devices may collect the onboard tracking data 110. The vehicle tracking program 150 may receive the onboard tracking data 110 from the onboard vehicle devices. The onboard vehicle devices may be selected from a group consisting of: (a) a compass; (b) a steering wheel angle sensor; (c) an accelerometer; (d) an odometer; (e) a speedometer; (f) a clock; (g) a gyroscope; and (h) a tire rotation sensor. As used herein, onboard sensor data excludes remote communication such as GPS or other satellite navigation systems as well as other forms of geolocation such as triangulation from mobile communication towers or geocoding internet protocol addresses in a wirelessly accessed data network.

In an embodiment, the onboard vehicle devices collect the onboard tracking data 110 without the use of the global positioning system or mobile tower triangulation. That is, each onboard vehicle device is located on or within the vehicle. For example, a compass is configured to determine and track the cardinal direction in which the front of the vehicle is oriented, which in combination with detecting motion, gives the direction of such motion. As another example, a steering wheel angle sensor is configured to determine wheel position and, therefore, turn direction. As another example, an accelerometer is configured to determine vehicle acceleration, changes in speed, turns, and stops. As another example, an odometer determines vehicle distance traveled over a particular interval, which, in combination with the time of various events, provides the distance of individual legs of a journey. As another example, a speedometer is configured to determine vehicle speed, which, in combination with the time of various events, yields the distance traveled over particular legs of a journey. As another example, a clock or chronometer is configured to determine speed and/or the time of when different vehicle movements have taken place. As another example, a gyroscope is configured to determine changes in direction and/or orientation of the vehicle, such as following the path or a curving road or making a turn. As another example a wheel rotation sensor is configured to determine which wheels are rotating and the absolute and relative speeds at which the wheels are rotating.

The vehicle tracking program 150 may receive the roadmap 120 as input. The roadmap 120 is a symbolic depiction highlighting relationships between elements of some space, such as objects, regions, and themes. The roadmap 120 map be two-dimensional or three-dimensional. The roadmap 120 includes street roads, intersections, and pathways that are accessible via a vehicle. The roadmap 120 may include elevation information. The roadmap 120 may include a scale. The roadmap 120 may include speed limit information. For example, the roadmap 120 may include that a certain road has a speed limit of thirty miles per hour.

The vehicle tracking program 150 may generate the vehicle path 130 as output. The vehicle path 130 may be overlaid onto the roadmap 120. The vehicle path 130 may be a written description of turn-by-turn directions that were taken by a vehicle.

In an example, a vehicle is begins moving at point A. The vehicle tracking program 150 notes start location coordinates 105 for point A. Onboard tracking data may include that the vehicle traveled in a northbound direction (collected from a compass) at 30 miles per hour (collected from a speedometer) for two minutes (collected from a chronometer). Onboard tracking data may further include that the vehicle decelerated to 12 miles per hour (collected from an accelerometer and/or a speedometer) turned the wheels ninety degrees (collected from a steering wheel angle sensor) accelerated to 30 miles per hour (collected from a speedometer and/or an accelerometer) and continued to travel in a westbound direction (collected from a compass) for five minutes (collected from a chronometer) before decelerating to zero miles per hour (collected from an accelerometer and/or speedometer) and shutting down the vehicle at point B. The vehicle tracking program 150 notes shut down location coordinates for point B.

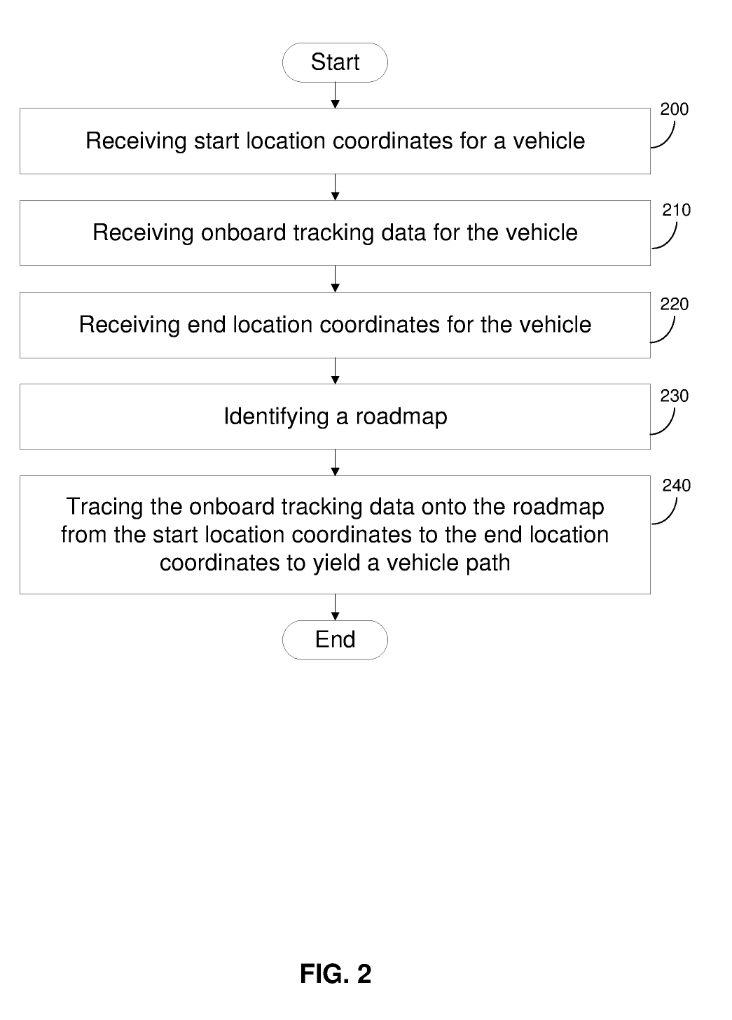

FIG. 2 is a flowchart depicting the operational steps of the vehicle tracking program 150, executing within the operational environment 100 of FIG. 1, in accordance with an embodiment of the present invention.

At step 200, the vehicle tracking program 150 receives the start location coordinates 105 for the vehicle. Receiving may include a user explicitly calling the vehicle tracking program 150 from a command line interface using a reference to the start location coordinates 105 as an argument. Alternatively, receiving may include automated calls to the vehicle tracking program 150, for example, from an integrated development environment or as part of a vehicle tracking management system. The vehicle tracking program 150 may receive the start location coordinates 105 from an externally communicating device, such as a global positioning receiving device. In the potential absence of communication at vehicle startup, the vehicle tracking program 150 may use the last known location of the vehicle by the external system. Furthermore, either the vehicle tracking program 150 or an external system may perform backtracking upon the journey's completion to infer the start location from the route and the end location.

At step 210, the vehicle tracking program 150 receives the onboard tracking data 110. In some embodiments, the vehicle tracking program 150 receives the onboard tracking data 110 from an external system. The external system is a system separate from the vehicle that is capable to receiving onboard sensor data from an onboard vehicle device.

At step 220, the vehicle tracking program 150 receives the end location coordinates 115 for the vehicle. The vehicle tracking program 150 may receive the end location coordinates 115 from an onboard vehicle device, such as a global positioning receiving device. In the potential absence of communication at vehicle shutdown, the vehicle tracking program 150 can store the outgoing data locally for transmission upon a connection becoming available.

At step 230, the vehicle tracking program 150 identifies the roadmap 120. Identifying may include a user explicitly calling the vehicle tracking program 150 from a command line interface using a reference to the roadmap 120 as an argument. Alternatively, receiving may include automated calls to the vehicle tracking program 150, for example, from an integrated development environment or as part of a vehicle tracking management system. The vehicle tracking program 150 may also use the start location and total distance traveled to infer an appropriate subset of the world map on which to trace the vehicle's route.

At step 240, the vehicle tracking program 150 traces the onboard tracking data 110 onto the roadmap 120 from the start location coordinates 105 to the end location coordinates 115 to yield the vehicle path 130. Tracing may include the vehicle tracking program 150 starting at the start location coordinates 105 and plotting movement associated with the vehicle. The movement associated with the vehicle may be in a direction, at a speed, for a known amount of time. The direction may be determined by a compass. The speed may be determined by a speedometer. The time may be determined by a chronometer.

In some embodiments, the vehicle tracking program 150 may send the vehicle path 130 to a third party device. For example, the vehicle tracking program 150 may send the vehicle path 130 to a machine learning system or a law enforcement system.

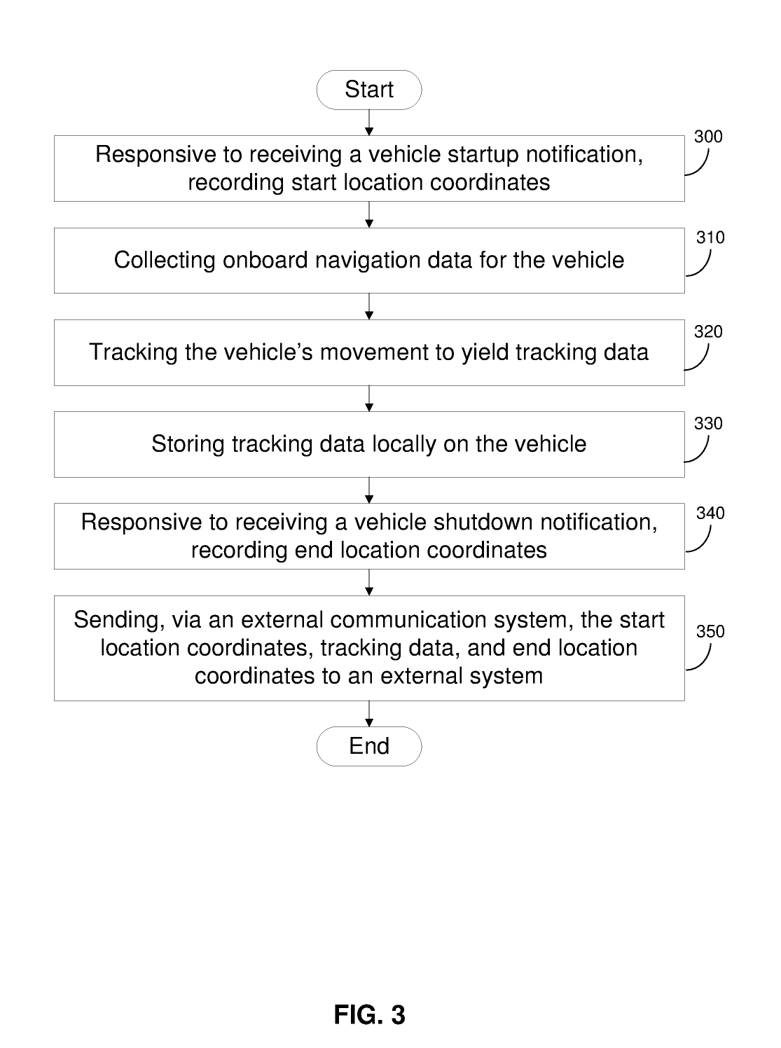

FIG. 3 is a flowchart depicting the operational steps of a vehicle tracking program 150 sending data to an external communication system, executing within the operational environment 100 of FIG. 1, in accordance with an embodiment of the present invention. In such an embodiment, sensor data may be collected without electronic communication with any device that is remote to the vehicle. As used herein, “collected” is distinguished from “transmitted”. Thus, according to various embodiments, sensor data is collected and stored locally onboard with the use of external data collection, however the sensor data may still be transmitted at the endpoints without such transmission constituting “collection” as used herein.

At step 300, the vehicle tracking program 150 is responsive to receiving a vehicle startup notification. The vehicle tracking program 150 responds by recording the start location coordinates 105 for the vehicle. Recording the start location coordinates 105 may include the vehicle tracking program 150 accessing an onboard vehicle device, such as a global positioning receiver device.

At step 310, the vehicle tracking program 150 collects onboard sensor data for the vehicle. The vehicle tracking program 150 may collect onboard sensor data from an onboard vehicle device within the vehicle. In some embodiments, the onboard sensor data is similar to the onboard tracking data 110.

At step 320, the vehicle tracking program 150 tracks the vehicle's movement based on the onboard sensor data to yield tracking data. Tracking the vehicle's movement may include charting where the vehicle is moving, how fast the vehicle is moving, and for how long the vehicle is moving. Tracking data may be the onboard sensor data organized sequentially, and/or based on location. At step 330, the vehicle tracking program 150 stored tracking data locally on the vehicle.

At step 340, the vehicle tracking program 150 is responsive to receiving a vehicle shutdown notification. The vehicle tracking program 150 responds by recording the end location coordinates 115 for the vehicle. Recording the end location coordinates 115 may include the vehicle tracking program 150 accessing an onboard vehicle device, such as a global positioning receiver device.

At step 350, the vehicle tracking program 150 sends, via an external communication system, the start location coordinates 105, the tracking data, and the end location coordinates 115 to an external system. An external communication system is a system that is separate from the vehicle. The external system may be a system within the external communication system. The external system is also separate from the vehicle.

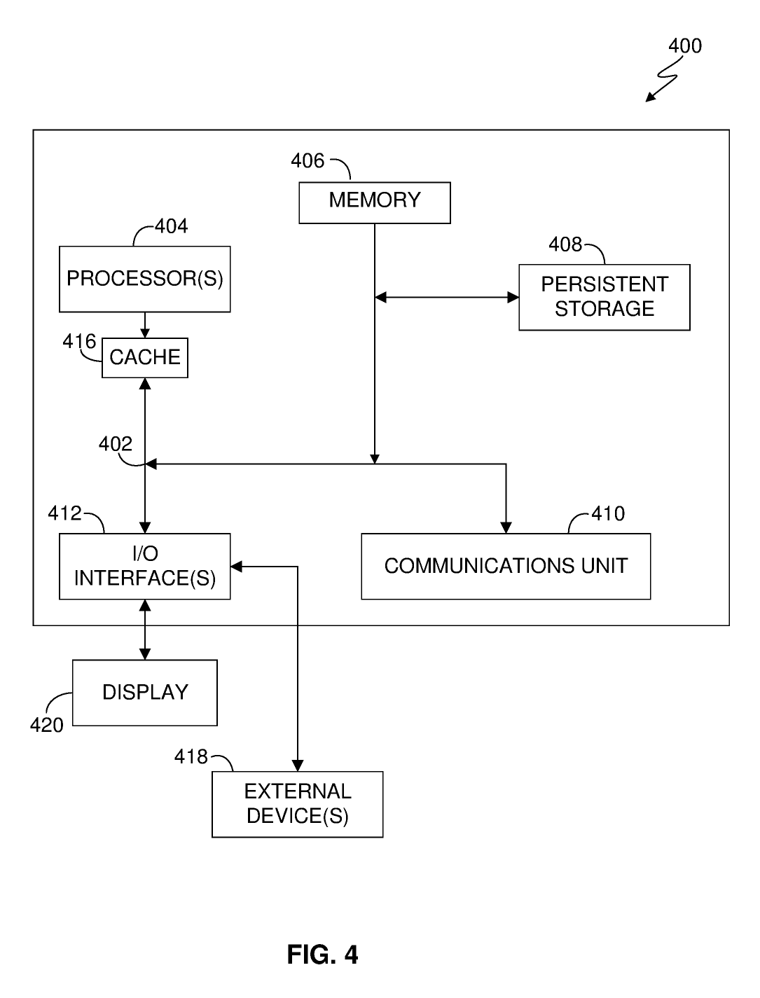

FIG. 4 is a block diagram depicting components of a computer 400 suitable for executing the vehicle tracking program 150. FIG. 4 displays the computer 400, the one or more processor(s) 404 (including one or more computer processors), the communications fabric 402, the memory 406, the RAM 416, the cache 416, the persistent storage 408, the communications unit 410, the I/O interfaces 412, the display 420, and the external devices 418. It should be appreciated that FIG. 4 provides only an illustration of one embodiment and does not imply any limitations with regard to the environments in which different embodiments may be implemented. Many modifications to the depicted environment may be made.

As depicted, the computer 400 operates over a communications fabric 402, which provides communications between the cache 416, the computer processor(s) 404, the memory 406, the persistent storage 408, the communications unit 410, and the input/output (I/O) interface(s) 412. The communications fabric 402 may be implemented with any architecture suitable for passing data and/or control information between the processors 404 (e.g. microprocessors, communications processors, and network processors, etc.), the memory 406, the external devices 418, and any other hardware components within a system. For example, the communications fabric 402 may be implemented with one or more buses or a crossbar switch.

The memory 406 and persistent storage 408 are computer readable storage media. In the depicted embodiment, the memory 406 includes a random access memory (RAM). In general, the memory 406 may include any suitable volatile or non-volatile implementations of one or more computer readable storage media. The cache 416 is a fast memory that enhances the performance of computer processor(s) 404 by holding recently accessed data, and data near accessed data, from memory 406.

Program instructions for the vehicle tracking program 150 may be stored in the persistent storage 408 or in memory 406, or more generally, any computer readable storage media, for execution by one or more of the respective computer processors 404 via the cache 416. The persistent storage 408 may include a magnetic hard disk drive. Alternatively, or in addition to a magnetic hard disk drive, the persistent storage 408 may include, a solid state hard disk drive, a semiconductor storage device, read-only memory (ROM), electronically erasable programmable read-only memory (EEPROM), flash memory, or any other computer readable storage media that is capable of storing program instructions or digital information.

The media used by the persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of the persistent storage 408.

The communications unit 410, in these examples, provides for communications with other data processing systems or devices. In these examples, the communications unit 410 may include one or more network interface cards. The communications unit 410 may provide communications through the use of either or both physical and wireless communications links. The vehicle tracking program 150 may be downloaded to the persistent storage 408 through the communications unit 410. In the context of some embodiments of the present invention, the source of the various input data may be physically remote to the computer 400 such that the input data may be received and the output similarly transmitted via the communications unit 410.

The I/O interface(s) 412 allows for input and output of data with other devices that may operate in conjunction with the computer 400. For example, the I/O interface 412 may provide a connection to the external devices 418, which may include a keyboard, keypad, a touch screen, and/or some other suitable input devices. External devices 418 may also include portable computer readable storage media, for example, thumb drives, portable optical or magnetic disks, and memory cards. Software and data used to practice embodiments of the present invention may be stored on such portable computer readable storage media and may be loaded onto the persistent storage 408 via the I/O interface(s) 412. The I/O interface(s) 412 may similarly connect to a display 420. The display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
responsive to receiving a vehicle startup notification, recording, by one or more processors, start location coordinates corresponding to that location where a vehicle is started;
collecting, by one or more processors, onboard sensor data for said vehicle, wherein the onboard sensor data is collected by onboard vehicle devices, said onboard vehicle devices including each of: a compass, a steering wheel angle sensor, an accelerometer, an odometer, a speedometer, a clock, a gyroscope, and a tire rotation sensor;
wherein said onboard sensor data is collected without electronic communication with any device remote to said vehicle
tracking, by one or more processors, said vehicle's movement, based at least on said onboard sensor data to yield tracking data;
storing, by one or more processors, said tracking data locally on said vehicle;
responsive to receiving a vehicle shutdown notification, recording, by one or more processors, end location coordinates corresponding to that location where said vehicle is shut down; and
sending, by one or more processors, via an external communication system, said start location coordinates, said tracking data, and said end location coordinates to an external system.
